(19) United States
(12) Patent Application Publication
(10) Pub. No.: US 2008/0300896 A1
(43) Pub. Date: Dec. 4, 2008

(54) Congregant recruitment method

(76) Inventor: Larry Gene Aikens, JR., Williamsport, MD (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/806,280

(22) Filed: May 31, 2007

(51) Int. Cl. G06Q 30/00

(52) U.S. Cl. 705/1

(57) ABSTRACT

A sales method is initiated by providing a product for acquisition by consumers. Next, a surveyor is sent door-to-door in a neighborhood to determine the level of interest of consumers in acquiring the product in the neighborhood. Next, a salesman is sent to consumers, determined by the surveyor to be interested in acquiring the product, to sell the product. Finally, a serviceman services the product acquired by consumers through the efforts of the salesman.

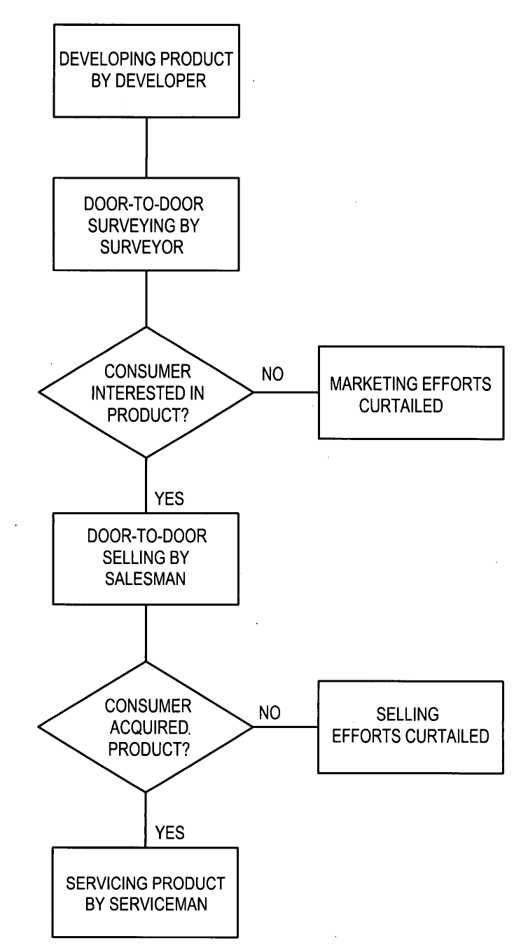

### FIELD OF THE INVENTION

The present invention relates generally to business practices and, more particularly, to promotional programs.

### BACKGROUND OF THE INVENTION

For more than two thousand years, evangelists have used different approaches to spread Christianity throughout the world. Some of these evangelical approaches are controversial and are employed in limited, geographic areas. Most new approaches to evangelism, however, are inoffensive to most people and have worldwide appeal.

Open-air preaching is the most basic approach to evangelism. Preaching of this sort involves the delivery of a sermon to a group of people in a public place. The earliest open-air preacher of Christianity was Jesus whose Sermon on the Mount occurred on a mountainside. After the death of Jesus, many of his followers preached the Gospel outdoors. Later, open-air preaching was employed by Protestants forbidden from preaching inside Catholic churches. Today, many open-air preachers are renowned for their sermons delivered in parks and sports stadiums.

Instead of going outside, many churches regularly offer a Gospel message preached indoors. Often, the message will conclude with an altar call where people are invited to come forward and accept Christ. The use of altar calls is controversial since they can create false conversions. Simply stated, there is little opportunity with altar calls for the newly converted to show that their faith is authentic and that they follow the teachings of Christ.

Televangelism presents a sermon through the medium of television. Large Christian television networks feature charismatic televangelists that cater their Gospel messages to audiences that can include millions of viewers. Televangelism began in the United States with the advent of television and remains a primarily evangelical Protestant approach to spreading the Gospel. Since it is costly to produce a television program, there a large barriers to entry into the field of televangelism.

Lifestyle evangelism can cost very little and is characterized by an individual demonstrating his faith by his actions in the hope that observers will be impressed and become Christian. Lifestyle evangelists note that Jesus drew people to God by showing kindness and by performing good works. This approach is powerful since observers recognize that it is harder to live righteously than to preach. Lifestyle evangelism can be, however, a slow way to present the Gospel to others.

Phone fishing occurs when an evangelist uses a telephone to spread the Gospel to others. Sometimes the telephone calls are made randomly to prospective Christians. More productive “fishing” occurs, however, when calls are made upon the recommendation of individuals who know the intended recipients of the calls.

Evangelism can take place on the Internet. In this forum, evangelism be found in websites defending the accuracy of the Bible as well as in chat rooms discussing faith in Jesus. Only the imaginations of those communicating via the Internet set the bounds for evangelism in an on-line environment, but it is increasingly difficult to make one's evangelical message stand out from the clutter of thousands of other competing messages.

Door-to-door preaching is a personal approach to evangelism where an evangelist will visit every home in a geographic area to discuss the Gospel with residents. The discussions are often accompanied by the distribution of tracts which are leaflets with a Gospel message. Groups such as the Jehovah's Witnesses and Mormons are known for spreading their message by door-to-door preaching to people in their homes.

While there are evangelists that employ only one method of winning converts to Christianity, there are others who simultaneously use many approaches. These evangelists reason that at least one of the approaches is liable to win converts. Such an unfocused approach, however, can waste of resources and yield marginal results.

Regardless of the particular approach(es) employed in the past, evangelization can be inefficient and slow. One evangelist can only deliver a finite number of sermons or altar calls. Beyond that, only a few can see that the evangelist is living a Christian life. Of course, the evangelist cannot make more than a few uninvited knocks at the door, or telephone calls, without loosing any goodwill engendered in a prospective convert. Thus, a good evangelist is often frustrated.

### SUMMARY OF THE INVENTION

In light of the problems associated with conventional, evangelistic processes, I propose a new method for evangelization that effectively and systematically reaches large numbers of prospective converts to the ministries of churches. My method mobilizes people in a particular church in an organized way, much like a company mobilizes its work force. This method not only reaches people with little contact with the Gospel, but, also, leads to their baptism and membership in a church.

My method builds upon the biblical concept of outreach to a community. The Bible tells of how John the Baptist prepared the way for Jesus' ministry. Later, the Bible states that Jesus ordained twelve apostles and seventy other disciples to go out and spread the Gospel in communities that Jesus would soon visit. This has suggested to me that enthusiastic believers, with little or no experience in evangelization, could get involved in sending people to a particular pastor or church. In the end, the pastor, usually an experienced evangelist and others h brings to a similar level of proficiency, can efficiently focus his time and effort in evangelizing people that are known to be receptive to his message.

My method is simple, inoffensive, and highly profitable. It does not require the costly establishment of a phone bank as is required with phone fishing which is considered by many to be offensive and off-putting. With minimal training, my process can mobilize members of new and existing churches who have never been involved before in evangelism. Further, my method can be utilized not only by churches for the purposes of evangelization, but can be used by just about any businesses seeking to sell a product.

It is an object of the invention to provide improved steps and arrangements thereof in a congregant recruitment method for the purposes described that is inexpensive to perform and dependable in use.

Briefly, my method in accordance with this invention achieves the intended objects by providing a product for acquisition by consumers. Next, a surveyor is sent door-to-door in a neighborhood to determine the level of interest of consumers in acquiring the product in the neighborhood. Next, a salesman is sent to consumers, determined by the surveyor to be interested in acquiring the product, to sell the product. Finally, a serviceman services the product acquired by consumers through the efforts of the salesman. In the context of evangelism, the product is the Gospel that is acquired by a prospective congregant through an expression of faith. The evangelist services and strengthens the product through indoctrination classes that make the prospective congregant into a full-fledged member of the evangelist's church.

The foregoing and other objects and advantages of my method will become readily apparent upon further review of the following detailed description of my method as illustrated in the accompanying drawings.

### BRIEF DESCRIPTION OF THE DRAWING

My method can be more readily described with reference to the accompanying drawing in which the several steps of my method are illustrated schematically in a flow chart.

### DETAILED DESCRIPTION OF THE METHOD

Referring now to the drawing, my congregant recruitment or sales method is shown schematically. My method has four, principal steps: product developing, surveying, selling, and servicing with the progress of interactions with prospective congregants being closely tracked by the team of people using the method. These principal steps, it is believed, are needed for an evangelist to be effective in the present day.

With evangelism being a principal aim of my method, product developing is complete in the message of the Gospel. The Gospel (God's Only Solution for People Eternally Lost) is the “product” that is marketed, sold, and serviced in the context of my exemplary description. My method, however, can extend to any tangible or intangible thing of value to people. If the product is a tangible one that is not found in nature, developing comprises, at least, the steps of designing, making, and packaging the product. With agricultural and mineral products, developing may require the additional steps of collecting, sorting, and refining.

Surveying is accomplished by mobilizing unskilled, but enthusiastic, believers to connect with their community for Christ. Every member of a church is invited to take part in administering the survey to potential congregants. The task of a surveyor is to “prepare the way” for the evangelist by conducting a door-to-door survey in an assigned area whose aim is to locate potential congregants for the church. The survey requires the completion of a printed form by a surveyor using input from a potential congregant.

The survey form looks for only a few pieces of information. First, the form requires the name, address, and age of the potential congregant. The potential congregant is also asked whether he is a member of a church and whether he attends Sunday services. Additionally, the potential congregant is queried about his faith in God with questions regarding: how a person gets to Heaven and whether the potential congregant is one hundred percent certain that he is going to Heaven. Only one or two minutes are required by a surveyor to complete the survey form with the addition of information proffered by a potential congregant.

To assist surveyors in their mission, they are provided with written materials in addition to survey forms. Commitment forms, for example, get surveyors to dedicate their time to an evangelist in a formal way and may request as little as thirty minutes of surveying time on a set date. Also, assignment sheets, prepared by the evangelist, or a designated agent, offer maps or descriptions of the areas to be surveyed. Instruction booklets give encouragement to surveyors and help them use their time efficiently by suggesting that, while surveying, they stay on message, avoid chatter, and refrain from overly long rest breaks. A weekly report allows the surveyor to provide to the evangelist, or an agent thereof, a record of the numbers of: homes reached, surveys completed, and the conversion prospects acquired.

Tracts are provided to surveyors to give to prospective congregants after a survey is completed. The tracts contain a Gospel message in addition to the name of a church with which a surveyor and evangelist are associated. A schedule of church services, church telephone number, and a map directing the potential congregant to the church are printed on the tract. The tracts are given freely and are even left on the doors of homes found to be unoccupied by their owners when the surveyor called.

If a potential congregant, by providing positive responses to the survey, indicates an interest in joining the church of the evangelist, a salesman visits him at his home. The salesman is a trained to present compelling passages from the Gospel and to seek a commitment to become baptized in the church of the evangelist, i.e., the salesman is sent to “close the deal.” Put plainly, the potential congregant is solicited to join the church of the evangelist to which the congregant will tithe. Again, the product being sold need not be baptism or membership in a particular church, but may include any tangible or intangible thing of value.

With evangelization as the goal, the salesman seeks to “sell” a church and its evangelizing leader or evangelist to those who have completed the survey, expressing uncertainty about their salvation, but indicating some interest in knowing more about eternal life. It is the duty of the salesman to give every potential congregant an opportunity to hear a clear presentation of the Gospel and encourage the prospective congregant to make a decision to trust Christ as his Savior, i.e., decide to become baptized in the evangelist's church. Great care must be taken to avoid a negative response.

To assist salesmen in their mission, they are provided with written materials. Commitment forms get salesmen to dedicate their time to an evangelist in a formal way. Additionally, assignment sheets, prepared by the evangelist or a designated agent, offer the names and addresses of potential congregants located during a survey as noted above. Instruction booklets give preaching and sales tips to salesmen and help them use their time efficiently. A weekly report allows the salesman to tally for the evangelist, or an agent thereof, the numbers of homes reached and conversion prospects committed to a new baptism.

Tracts are provided to salesmen to give to prospective congregants after a meeting with one another. The tracts contain a Gospel message, perhaps on the topic of the certainty of reaching Heaven, which could be different from those of the surveyors to maintain the interest of a potential congregant. As with the tracts provided by surveyors, the salesmen's tracts remind the potential congregant of the name of a church with which a salesman and an evangelist is associated. A schedule of church services, church telephone number, and a map directing the potential congregant to the church are printed on the salesmen's tract. The salesmen's tracts are given freely.

Servicing the product in the context of evangelism involves the making of a potential congregant into a congregant. Servicing is initiated by a serviceman, i.e., the church leader or evangelist, visiting the home of a potential congregant after a salesman has obtained a commitment from the potential congregant to attend a Sunday worship service at the church of the evangelist or to become baptized in that church. It is the intent of the visit to obtain a further commitment on the part of the potential congregant to attend a multi-session, indoctrinating class in the Gospel. The class is taught by the evangelist, or an agent thereof, and, serves to welcome the potential congregant to the church and direct him toward spiritual growth and baptism. After completing the class and becoming baptized, the potential congregant is now a congregant, a full member of the church.

When tangible products, rather intangibles like personal salvation, are the being bought and sold by means of my method, the serviceman would seek to repair broken goods and engender goodwill and further educate the buyer. A sales offer for additional products may be made by the serviceman to the prospective buyer.

Printed materials aid the serviceman/evangelist. For instance, the serviceman/evangelist maintains a weekly list of potential congregants that he visited and the positive or negative results of the visits made with the potential congregants. Instruction booklets give preaching and sales tips to new servicemen who are serving as agents for the evangelist. A curriculum for the indoctrinating class forms a guide to the subject matter for both the evangelist and the potential congregant alike. Report cards of the potential congregant's progress are kept by the serviceman/evangelist to aid in locating training deficiencies.

By following the method set forth hereinabove, a small church that serves a limited geographic area can be rapidly grown into one with a regional or national presence. Performance of the method steps is distributed among several specialists such as: developers, surveyors, salesmen, and servicemen for great efficiency. The serviceman/evangelist can focus his efforts on winning souls.

While my method has been described with a high degree of particularity, it will be appreciated by those skilled in the art that modifications can be made to it. Therefore, it is to be understood that the present invention is not limited to the method for evangelizing described above, but encompasses any and all methods within the scope of the following claims.

I claim:

1. A sales method, comprising the steps of:
providing a first product for acquisition by consumers;
providing a surveyor for determining the level of interest of consumers in acquiring said first product;
sending said surveyor door-to-door in a neighborhood to determine the level of interest of consumers in acquiring said first product in the neighborhood;
providing a salesman for selling said first product to consumers;
sending said salesman to consumers, determined by said surveyor to be interested in acquiring said first product, to sell said first product;
providing a serviceman for servicing said first product acquired by consumers through the efforts of said salesman; and,
servicing said first product by said serviceman.

2. The sales method according to claim 1, further comprising the steps of:
providing a second product for acquisition by consumers; and,
educating consumers about said second product by said serviceman.
